(19) United States
(12) Patent Application Publication
(10) Pub. No.: US 2008/0061535 A1
(43) Pub. Date: Mar. 13, 2008

(54) Airbag sleeve

(76) Inventors: Stephen M. Everard, Rochester, MI (US); James T. Kirchen, Chippewa Falls, WI (US); Brock T. Cooley, Bloomer, WI (US); Eric G. Parker, Chicago, IL (US); Thomas S. King, Evanston, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/881,165

(22) Filed: Jul. 25, 2007

Related U.S. Application Data
(60) Provisional application No. 60/843,182, filed on Sep. 8, 2006.
(60) Provisional application No. 60/855,925, filed on Nov. 1, 2006.

(51) Int. Cl. B60R 21/20

(52) U.S. Cl. 280/728.2

(57) ABSTRACT

An airbag sleeve configured to securely retain an airbag includes a main body, a first latching member, and a second latching member. The main body includes first and second edges and defined an airbag retention area. The first latching member is connected to the first edge, while the second latching member is connected to the second edge. The first and second latching members are configured to interlock together in a closed position in order to securely retain the airbag within the airbag retention area. The first and second latching members are also configured to separate from one another when the airbag deploys.

### RELATED APPLICATIONS

This application relates to and claims priority benefits from U.S. Provisional Patent Application No. 60/843,182 entitled “Maxi-Grip Airbag Sleeve,” filed Sep. 8, 2006, which is hereby incorporated by reference in its entirety. This application also relates to and claims priority benefits from U.S. Provisional Application No. 60/855,925 entitled “Maxi-Grip Airbag Sleeve,” filed Nov. 1, 2006, which is also hereby incorporated by reference in its entirety.

### FIELD OF THE INVENTION

Embodiments of the present invention generally relate to airbags configured for use with automobiles, and more particularly to a sealed sleeve that safely and securely retains an airbag before deployment.

### BACKGROUND OF THE INVENTION

Automotive side curtain airbags continue to gain popularity among automobile manufacturers. Indeed, such airbags are a standard safety feature for an increasing number of automobiles every year. Typically, after an airbag is manufactured it is rolled up, and then sealed in a sleeve that keeps the airbag properly oriented and positioned until it is deployed.

A variety of sleeve designs are used by major airbag manufacturers. An airbag sleeve is typically formed of plastic or fabric. Velcro, adhesives, or heat-welding are used to close the sleeve around an airbag. When an airbag is deployed, the sleeve tears in order to allow the airbag to inflate and expand.

Using Velcro and/or adhesives, however, adds costs and time to the manufacturing process. Further, the use of tape by itself to close the sleeve around an airbag leads to increased post-manufacture inspection time and vigilance. Additionally, heat-welding adds time and labor costs to the manufacturing process.

Conventional airbags may also be rolled up and inserted into a fabric sock. Fabric tabs extend from the rolled bag at various points. Metal stamped parts are then folded over the fabric tabs. The metal stamped parts may then be bolted onto sheet metal of a structure, such as an automobile frame.

A conventional airbag is flimsy and loose when positioned within a fabric sock. Thus, the process of assembling and installing the airbag may prove cumbersome and tedious.

### SUMMARY OF THE INVENTION

Embodiments of the present invention provide an improved airbag sleeve system that is unexpectedly easy to assemble and install. The airbag sleeve system securely retains an airbag prior to deployment, and opens to allow the airbag to expand during deployment.

Certain embodiments of the present invention provide an airbag sleeve configured to securely retain an airbag. The airbag sleeve comprises a main body, a first latching member, and a second latching member.

The main body has first and second edges, and defines an airbag retention area. The first latching member is connected to the first edge, while the second latching member is connected to the second edge.

The first and second latching members are configured to interlock together in a closed position in order to securely retain the airbag within the airbag retention area in a pre-deployed state. The first and second latching members are also configured to separate from one another when the airbag deploys and expands.

The first latching member may include first and second channels separated by a first rail. The second latching member may include second and third rails separated by a third channel. The first and second channels mate with the second and third rails, and the first rail mates with the third channel in order to close the airbag sleeve. During deployment, these mating interfaces are separated.

One or both of the first and second latching members may include a perforation over a length thereof. The perforation ensures a controlled tear when the airbag is deployed.

The main body of the airbag sleeve may include an angled end. That is, a portion of the main body may be cut at an angle. The angled end also ensures a controlled tear when the airbag is deployed.

The first and second latching members may be different lengths. As such, an airbag sleeve opening may already be started where the ends do not longitudinally align. Thus, the different lengths may also ensure a controlled tear when the airbag is deployed.

Certain embodiments of the present invention also provide an automobile airbag system that includes an airbag and an airbag sleeve. The airbag sleeve securely retains the airbag in a pre-deployed state and opens to allow the airbag to expand in a deployed state.

The airbag may include a flap that is anchored to the airbag sleeve. The main body of the airbag sleeve may include first and second wall portions that compressively sandwich the flap therebetween. Alternatively, the main body may include a flap-anchoring slot that anchors the flap to the airbag sleeve.

The thickness of the main body of the airbag sleeve may vary. For example, the main body may include a thick portion and a thin portion. The thick portion of the main body provides rigidity and strength and may abut against a structure. The thin portion provides flexibility and may be distally located from the structure.

### DESCRIPTION OF SEVERAL VIEWS OF THE DRAWINGS

FIG. 1 illustrates an isometric view of an airbag and airbag sleeve according to an embodiment of the present invention.

FIG. 2 illustrates an isometric view of an airbag being positioned within an airbag sleeve according to an embodiment of the present invention.

FIG. 3 illustrates an isometric view of an airbag securely retained within an airbag sleeve according to an embodiment of the present invention.

FIG. 4 illustrates an isometric view of an airbag sleeve according to an embodiment of the present invention.

FIG. 5 illustrates a cross-sectional view of the fastening members of and airbag sleeve according to an embodiment of the present invention.

FIG. 6 illustrates an isometric view of an airbag sleeve according to an embodiment of the present invention.

FIG. 7 illustrates a cross-sectional view of an airbag system according to an embodiment of the present invention.

FIG. 8 illustrates a cross-sectional view of an airbag system according to an embodiment of the present invention.

FIG. 9 illustrates a cross-sectional view of an airbag system according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

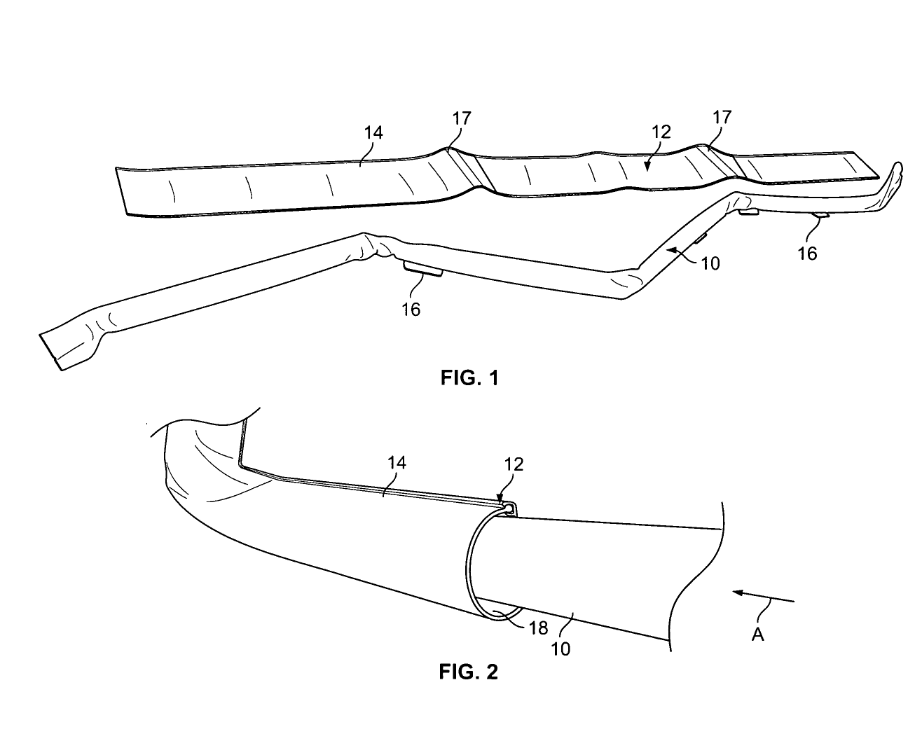

FIG. 1 illustrates an isometric view of an airbag 10 and airbag sleeve 12 according to an embodiment of the present invention. As shown in FIG. 1, the airbag 10 is in a pre-deployed, rolled orientation and is configured to be retained within the airbag sleeve 12. The airbag sleeve 12 is configured to receive and securely retain the airbag 10 within an interior airbag chamber or airbag retention area/space defined by a circumferential flexible wall 14.

The airbag 10 may include a series of mounting tabs 16 configured to extend through slots (not shown in FIG. 1) of the airbag sleeve 12. The mounting tabs 16 are used to fasten the airbag 10 and airbag sleeve 12 to a structure, such as sheet metal within a vehicle.

The airbag sleeve 10 may be formed of fabric, plastic or various other materials. For example, the airbag sleeve 12 may be an extruded plastic sheet, such as Thermoplastic Elastomer (Polypropylene). The airbag sleeve 10 includes a latch fastening system configured to open when the airbag 10 is deployed. The latch fastening system may include Maxi-Grip fastening devices, such as those manufactured by Illinois Tool Works of Glenview, Illinois. Maxi-Grip fastening devices are plastic extrusions with interlocking channels that reduce the risk of snagging, tearing, or breaking (as compared with zippers and other such conventional fastening devices). In order to close the latch fastening system, one end is closed, or started. In order to close the remainder, an operator exerts sliding pressure on the system in a first closing direction.

The airbag sleeve 12 may include a plurality of flexible ribs 17 positioned at various points over its length. The ribs 17 provide strength to the airbag sleeve 12 while allowing it to flex in those areas (similar to a flexible drinking straw). The ribs 17 provide increased flexibility to the airbag sleeve 12. Thus, the airbag sleeve 12 may be easily shaped to contours of various areas on or within a vehicle structure.

FIG. 2 illustrates an isometric view of the airbag 10 being positioned within the airbag sleeve 12. As shown in FIG. 2, the rolled airbag 10 may be inserted into the interior airbag chamber 18 of the airbag sleeve 12 in the direction of arrow A.

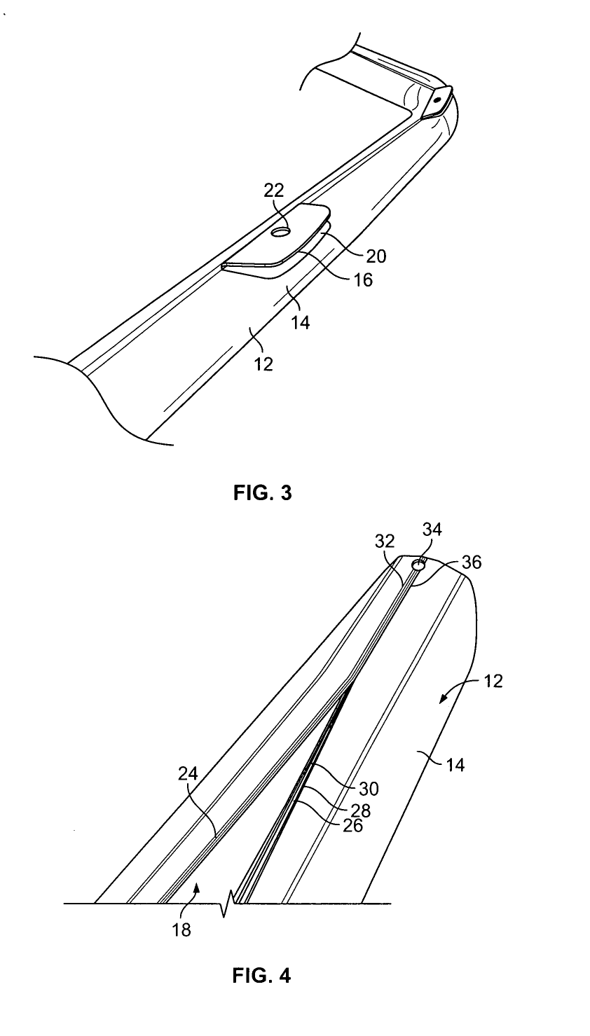

FIG. 3 illustrates an isometric view of the airbag 10 securely retained within the airbag sleeve 12. Once the airbag 10 is positioned within the airbag sleeve 12, the mounting tabs 16 are pulled or otherwise passed through the reciprocal slots 20 formed through the wall 14 of the airbag sleeve 12. Thus, the airbag 10 and the airbag sleeve 12 may be securely fastened to a structure through the mounting tabs 16. In particular, the mounting tabs 16 may be fastened to the structure through various fasteners, such as screws, bolts, and the like. The mounting tabs 16 may include through holes 22 to accommodate fasteners, pins, posts, or the like.

The airbag sleeve 12 may be delivered to a manufacturer as a finished part. Because the airbag sleeve 12 includes the reciprocal slots 20 that allow the mounting tabs 16 to pass therethrough, an automobile manufacturer does not have to process the airbag sleeve 12. That is, the manufacturer does not need to independently modify the airbag sleeve 12, such as by cutting passages for the mounting tabs 16, in order to allow the airbag 10 to be secured to a structure. Thus, the manufacturing process is efficient.

Alternatively, during an assembly process, the airbag sleeve 12 may be placed on a machine table and machine clamps may be fed through the slots 20 in the airbag sleeve 12. The airbag 10 would then be placed on top of the airbag sleeve 12, attached to the clamps by the mounting tabs 16 (e.g., via the through holes 22), and rolled up by a rolling machine. After the airbag 10 is rolled, the latch fastening system on the airbag sleeve 12 is securely latched in order to close the airbag sleeve 12 around the rolled airbag 10.

FIG. 4 illustrates an isometric view of the airbag sleeve 12. Latching members 24 and 26, such Maxi-Grip latching members, are located at end portions of the circumferential wall 14. The latching members 24 and 26 cooperate to selectively open and close the airbag sleeve 12. In particular, in order to close the airbag sleeve 12, one end of the latching members 24 and 26 are mated together, or started. An operator than exerts sliding pressure on the latching members 24 and 26 starting from the mated end in order to fully mate the latching members 24 and 26 and close the airbag sleeve 12. At least one of the latching members 24 and 26 includes two channels 28 and 30 that are configured to securely mate with reciprocal structures of the other of the latching members 24 or 26.

During assembly, the latching members 24 and 26 may be initially mated at one end 32. Once initially mated, a machine may finish sealing, that is, securely mating, the latching members 24 and 26 together over the length of the airbag sleeve 12. For example, an airbag sleeve 12 may be delivered with the end 32 already started in a closed orientation. An operator would then insert the rolled airbag 10 (shown in FIGS. 1-3) into the interior airbag chamber 18 of the airbag sleeve 12 and pull a small handle (not shown) attached to the latching members 24 and 26 over the length of the airbag sleeve 12. After the airbag sleeve 12 is securely closed around the airbag 10, the handle is removed to prevent it from ejecting during deployment of the airbag 10.

As shown in FIG. 4, the latching members 24 and 26 may be initially mated at the end 32. The end 32 may then be heat staked so that it cannot separate. A hole 34 may be punched through the heat stake 36. During assembly, an operator lays the airbag sleeve 12 flat on a table and pushes the hole 34 over a pin (not shown) on a work table. The airbag 10 (shown in FIGS. 1-3) would then be rolled up and positioned onto the center of the airbag sleeve 12. Because the end 32 of the airbag sleeve 12 is initially mated into a closed position, an assembly machine is able to locate the latching members 24 and 26 and seal the rest of the airbag sleeve 12. As such, the efficiency of the manufacturing process increases. This process also prevents or at least decreases the frequency of injuries from sealing the sleeves by hand.

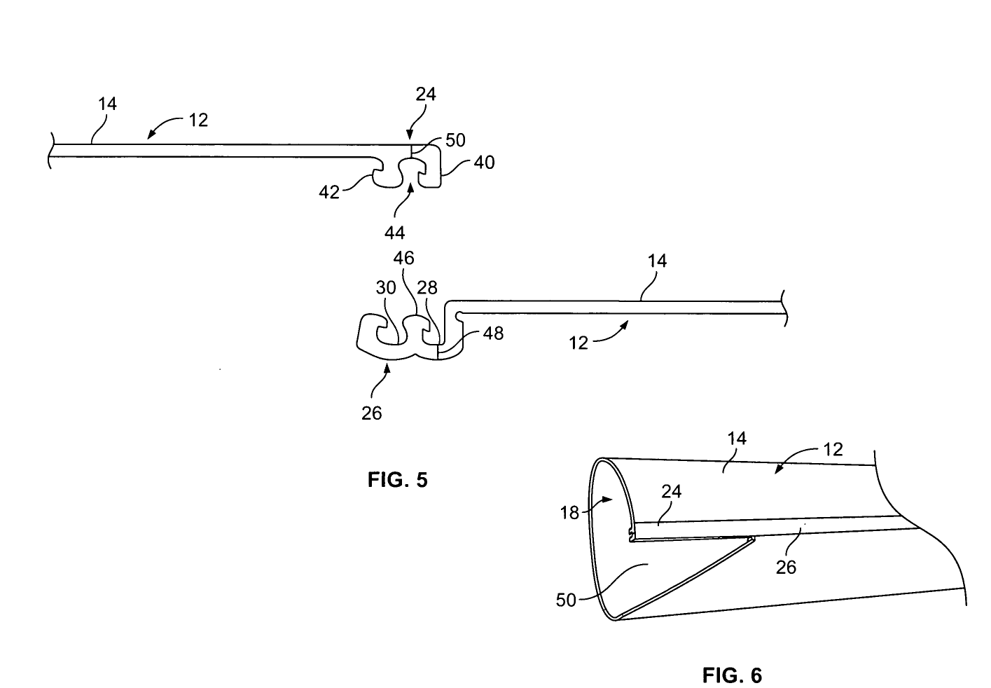

FIG. 5 illustrates a cross-sectional view of the latching members 24 and 26 of the airbag sleeve 12 according to an embodiment of the present invention. The latching members 24 and 26 provide a latch fastening system that readily opens during airbag deployment. As shown, the latching members 24 and 26 are located at distal edges of the wall 14. The latching member 24 includes two lips or rails 40 and 42 separated by a channel 44 over a length thereof. The latching member 26 includes the two channels 28 and 30 separated by a lip or rail 46 over a length thereof. The rails 40 and 42 are configured to slidably and securely mate with the channels 28 and 30, while the rail 46 is configured to slidably and securely mate with the channel 44.

Certain embodiments of the present invention use straight end cuts and are sealed by hand. During testing, these embodiments deployed as planned for ambient and hot temperatures. In order to control the opening of the airbag sleeve 12 during deployment, at least one slit may be formed with respect to the airbag sleeve 12.

As shown in FIG. 5, the latching member 26 may be perforated by cutting a small slit 48 proximate the channel 28 over a length of the latching member 26. The small slit 48 may optionally be positioned proximate the channel 30. A small slit 50 may be cut proximate and along the channel 44 of the latching member 24 in lieu of, or addition to, the small slit 48 on the latching member 26. If the temperature is cold enough that the latching members 24 and 26 become rigid and unable to release from one another, the plastic will tear about the slits 48 and/or 50. The slits 48 and 50 provide weakened areas that allow a tear to be controlled. Because a potential tear is controlled, the likelihood of plastic projectiles being ejected during airbag deployment is diminished. Thus, the slits 48 and/or 50 provide a controlled tearing safety feature that prevents projectile ejection during airbag deployment.

Various different shapes and patterns may be used for the slits 48 and 50. Optionally, instead of cutting the airbag sleeve 12, dimples may be formed thereon, and/or the airbag sleeve 12 may be scored.

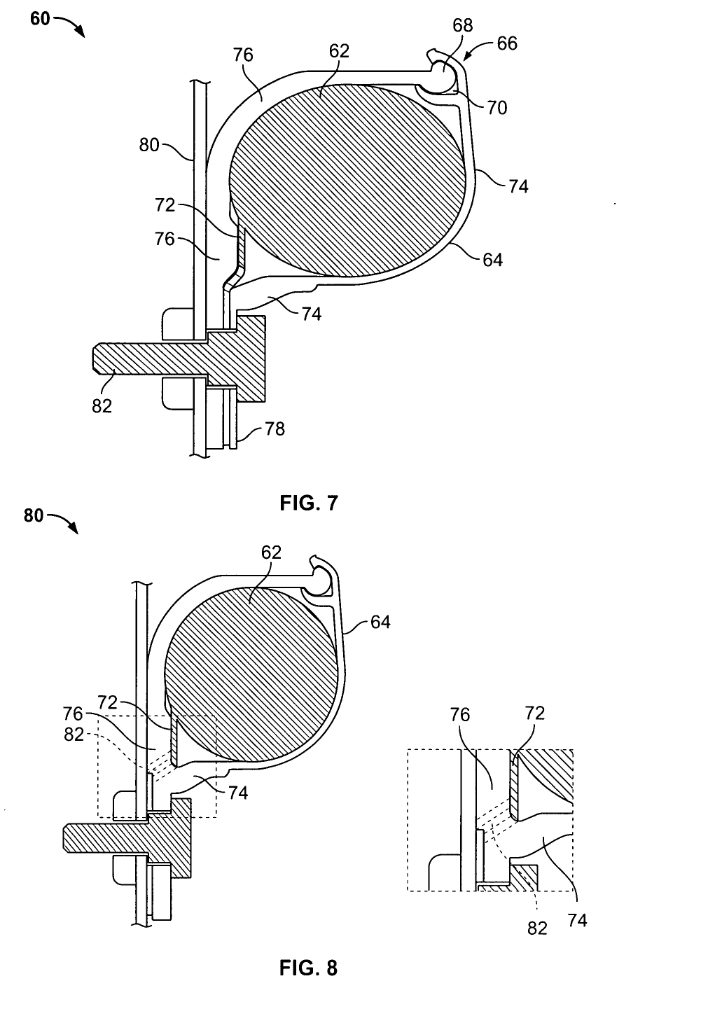

FIG. 6 illustrates an isometric view of the airbag sleeve 12 according to an embodiment of the present invention. Instead of slits formed proximate the latching members 24 and 26 as shown in FIG. 5, an end of the airbag sleeve 12 may be cut at an angle 50. As shown in FIG. 6, the airbag sleeve 12 may be cut such that a portion of the latching member 26 is removed. The removal of a portion of the airbag sleeve 12 at an end aids the release of the latching members 24 and 26 with respect to one another. The angled cut 50 allows the latching members 24 and 26 to be opened easier, thereby allowing the fastening members 24 to 26 to release from one another instead of the airbag sleeve 12 shattering.

FIG. 7 illustrates a cross-sectional view of an airbag system 60 according to an embodiment of the present invention. The airbag system 60 includes a rolled airbag 62 secured within an airbag sleeve 64. The airbag sleeve 64 is securely closed around the airbag 62 through a latching fastener 66 that includes a lip or rail 68 that is securely retained within a reciprocal groove 70. The latching fastener 66 may be similar to the latch fastening system discussed above that includes the latching members 24 and 26.

A flap 72 of the airbag 62 may be compressively sandwiched or pinched between wall portions 74 and 76 of the airbag sleeve 12 in order to anchor the airbag 62 to the airbag sleeve 64, even during deployment. The wall portions 74 and 76 may be components of a single wall structure, or may, alternatively, be separate and distinct walls. That is, the secured nature of the flap 72 between the wall portions 74 and 76 ensures that the airbag 62 does not detach from the airbag sleeve 64 during deployment. Also, the airbag sleeve 64 may include mounting tabs 78. Further, the airbag 62 may include mounting tabs, such as mounting tabs 16 shown in FIG. 3, that extend through slots (not shown) formed through the airbag sleeve 64.

As shown in FIG. 7, the airbag 62 and airbag sleeve 64 are secured to a structure 80 by way of a fastener, such as a bolt, securely fastening the airbag sleeve 64 and airbag 62 to the structure 80. The wall portion 76 proximate the structure 80 is thicker than the wall portion 74 distally located from the structure 80. The thickened wall portion 76 provides a strong securing base with respect to the structure 80, while the thinner wall portion 74 allows for easier deployment of the airbag 62. That is, the outward force directed by the airbag 62 is able to readily overcome the enclosing force exerted by the thinner wall portion 74. In fact, as shown in FIG. 7, the thickness of both walls portions 74 and 76 decreases the further away from the structure 80.

During deployment, the rolled airbag 62 inflates and expands. The force of inflation forces the latching fastener 66 to open, thereby allowing the airbag 62 to outwardly inflate and expand. As noted above, however, the pinched nature of the flap 72 of the airbag 62 between the wall portions 74 and 76 of the airbag sleeve 64 anchors the airbag 62 to the structure 80.

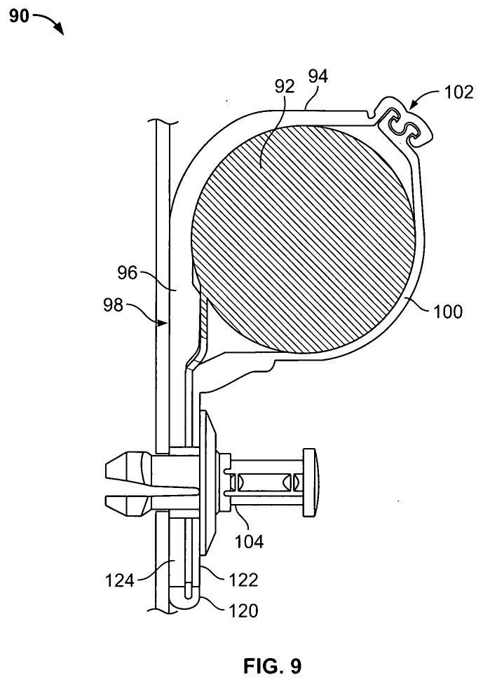

FIG. 8 illustrates a cross-sectional view of an airbag system 80 according to an embodiment of the present invention. In this embodiment, the airbag sleeve 64 includes a slot 82 formed through or between the wall portions 76 and 74, respectively. The flap 72 may be passed and/or weaved through the slot 82 to anchor the airbag 62 to the airbag sleeve 64. Alternatively, the flap 72 may be secured to the airbag sleeve 64 through separate fasteners. The wall portions 74 and 76 may be part of a single wall structure having slots 82 for airbag flaps.

FIG. 9 illustrates a cross-sectional view of an airbag system 90 according to an embodiment of the present invention. The airbag system 90 includes a rolled airbag 92 securely anchored and retained within an airbag sleeve 94, such as described above. As noted above, the airbag sleeve 94 includes a thickened wall portion 96 proximate a structure 98. The thickened wall portion 96 provides strength and rigidity proximate the structure. The airbag sleeve 94 also includes a thinner wall section 100 positioned away from the structure 98. The thinner wall section 100 provides flexibility so that the airbag 92 is able to readily open a latch fastening system 102 when the airbag 92 is deployed. The flap of the airbag 92 is secured with respect to the airbag sleeve 94 such as described above (e.g., pinched between walls of the airbag sleeve 94, weaved through slots of the airbag sleeve 94 walls, or secured through separate fasteners).

The latch fastening system 102 is similar to that shown and described in FIG. 5. The latch fastening system 102 may be a Maxi-Grip of U-Grip latch with or without perforations or slits. The location of the fastener 102 may be different than that shown in FIG. 9, depending on the deployment direction of the airbag 92.

The airbag sleeve 94 and airbag 92 are secured to the structure 98 through a fastener 104. The fastener 104 may be a shoulder bolt for a hard-joint. Also, the fastener 104 may be a plastic fastener securely retained within a sheet metal hole. Overall, the airbag 92 and airbag sleeve 94 may be secured to the structure 98 through a variety of fasteners.

A hinge 120 may also secure the a distal end of wall portion 122 to a distal end of wall portion 124. In this way, the hinge 120 may be selectively opened to allow an airbag flap to pass, and securely closed to clamp the flap between the wall portions 122 and 124. A hinge 120 may be used with respect to any of the embodiments shown in FIGS. 7-9.

Thus, embodiments of the present invention provide an improved airbag sleeve system that is unexpectedly easy to assemble and install. Embodiments of the present invention provide a system in which an airbag is easily assembled into an airbag sleeve. The airbag and airbag sleeve are then easily secured to a structure, such as sheet metal within a vehicle. Moreover, the latching fastener that encloses the airbag sleeve around the airbag provides a robust enclosure when the airbag is at-rest, but is readily opened when the airbag deploys.

While various spatial terms, such as upper, bottom, lower, mid, lateral, horizontal, vertical, and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. An airbag sleeve configured to securely retain an airbag comprising:
a main body having first and second edges, said main body defining an airbag retention area;
a first latching member connected to said first edge; and
a second latching member connected to said second edge, wherein said first and second latching members are configured to interlock together in a closed position in order to securely retain the airbag within said airbag retention area, and wherein said first and second latching members are configured to separate from one another when the airbag expands.

2. The airbag sleeve of claim 1, wherein said first latching member comprises first and second channels separated by a first rail, and wherein said second latching member comprises second and third rails separated by a third channel, wherein said first and second channels mate with said second and third rails, and wherein said first rail mates with said third channel.

3. The airbag sleeve of claim 1, wherein one or both of said first and second latching members comprise a perforation over a length thereof, wherein said perforation ensures a controlled tear when the airbag is deployed.

4. The airbag sleeve of claim 1, wherein said main body includes an angled end, wherein said angled end ensures a controlled tear when the airbag is deployed.

5. The airbag sleeve of claim 1, wherein said first and second latching members are different lengths, wherein said different lengths ensure a controlled tear when the airbag is deployed.

6. The airbag sleeve of claim 1, wherein said airbag sleeve further comprises at least one slot configured to allow a mounting tab of the airbag to pass therethrough.

7. The airbag sleeve of claim 1, wherein said main body is an extruded plastic sheet.

8. The airbag sleeve of claim 1, wherein a first end of said first latching member is heat staked to a second end of said second latching member.

9. An automobile airbag system comprising:
an airbag; and
an airbag sleeve that securely retains said airbag in a pre-deployed state and opens to allow said airbag to expand in a deployed state, said airbag sleeve comprising:
a main body having first and second edges, said main body defining an airbag retention area;
a first latching member connected to said first edge;
a second latching member connected to said second edge, wherein said first and second latching members are configured to interlock together in a closed position in order to securely retain said airbag within said airbag retention area before said airbag deploys, and wherein said first and second latching members are configured to separate from one another when said airbag deploys.

10. The system of claim 9, wherein said airbag comprises a flap that is anchored to said airbag sleeve.

11. The system of claim 10, wherein said main body comprises first and second wall portions, wherein said flap is compressively sandwiched between said first and second wall portions.

12. The system of claim 10, wherein said main body comprises a flap-anchoring slot, wherein said flap is anchored within said flap-anchoring slot.

13. The system of claim 9, wherein said main body comprises a thick portion and a thin portion, wherein said thick portion of said main body provides rigidity and strength and said thin portion provides flexibility.

14. The system of claim 9, wherein said first latching member comprises first and second channels separated by a first rail, and wherein said second latching member comprises second and third rails separated by a third channel, wherein said first and second channels mate with said second and third rails, and wherein said first rail mates with said third channel.

15. The system of claim 9, wherein one or both of said first and second latching members comprise a perforation over a length thereof, wherein said perforation ensures a controlled tear when the airbag is deployed.

16. The system of claim 9, wherein said main body includes an angled end, wherein said angled end ensures a controlled tear when the airbag is deployed.

17. An airbag sleeve configured to securely retain an airbag, the airbag and airbag sleeve configured to be securely fastened to a structure within an automobile, the airbag sleeve comprising:
a main body formed of plastic and having first and second edges, said main body defining an airbag retention area;
at least one slot formed through said main body and configured to allow a mounting tab of the airbag to pass therethrough;
a first latching member connected to said first edge, said first latching member comprising first and second channels separated by a first rail; and
a second latching member connected to said second edge, said second latching member comprising second and third rails separated by a third channel, wherein said first and second latching members are configured to interlock together in a closed position in order to securely retain the airbag within said airbag retention area before the airbag deploys, and wherein said first and second latching members are configured to separate from one another when the airbag deploys.

18. The airbag sleeve of claim 17, wherein one or both of said first and second latching members comprise a perforation over a length thereof, wherein said perforation ensures a controlled tear when the airbag is deployed.

19. The airbag sleeve of claim 17, wherein said main body includes an angled end, wherein said angled end ensures a controlled tear when the airbag is deployed.

20. The airbag sleeve of claim 17, wherein a portion of said first latching member is heat staked to a portion of said second latching member.
